(19) United States
(12) Patent Application Publication
(10) Pub. No.: US 2003/0184845 A1
(43) Pub. Date: Oct. 2, 2003

(54) Optical element using one-dimensional photonic crystal and optical device using the same

(76) Inventors: Shigeo Kittaka, Osaka (JP); Kazuaki Oya, Osaka (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/397,284

(22) Filed: Mar. 27, 2003

(30) Foreign Application Priority Data
Mar. 27, 2002 (JP) P2002-089995

(51) Int. Cl. G02F 1/00

(52) U.S. Cl. 359/321

(57) ABSTRACT

A phase modulation unit is provided in an end surface of one-dimensional photonic crystal to phase-modulate input light in the same period and direction as those of the photonic crystal and propagate only specific high-order band light in the photonic crystal to thereby increase the intensity of output light emerging from a surface of the one-dimensional photonic crystal used as a spectroscopic device, that is, to thereby improve efficiency in use of the input light. In addition, by the function of a structure added to the photonic crystal, the output light is distributed into one or both of opposite sides of the photonic crystal and the intensity of the output light is adjusted.

The present application is based on Japanese Patent Application No. 2002-89995, the entire contents of which are incorporated herein by reference.

### BACKGROUND OF THE INVENTION

1. Field of the Invention

The present invention relates to an optical element and a spectroscopic device mainly used in an optical communication system, an optical measuring machine, an external resonator of a laser, or the like.

2. Related Art

Increase in capacity of an optical fiber communication network has been demanded intensely with the rapid advance of popularization of the Internet in recent years. Development of WDM (wavelength division multiplexing) communication as a means for increasing the capacity has been advanced rapidly. In WDM communication, optically functional elements such as an optical demultiplexer, a filter and an isolator excellent in wavelength selectivity are required because various kinds of information are transmitted individually by light having slightly different wavelengths. It is a matter of course that mass production, miniaturization, integration, stability, etc. are strongly required of the functional elements.

An optical demultiplexer (or a spectroscopic device) is used for demultiplexing/detecting an optical signal multiplexed with a plurality of wavelengths artificially as in wavelength division multiplexing optical communication or for spectrally analyzing target light as in spectrometry. The optical demultiplexer needs spectroscopic elements such as a prism, a wavelength filter, and a diffraction grating. Particularly, the diffraction grating is a typical spectroscopic element. For example, a quartz or silicon substrate having a periodic micro prismatic structure formed in its surface is used as the diffraction grating. Diffracted light rays generated by the periodic micro prismatic structure interfere with one another, so that light having a specific wavelength emerges in a specific direction. This property is used for the spectroscopic element.

There is however a practical limit to the quantity of change of an emergence angle of light from the diffraction grating in accordance with the wavelengths. There is a problem that increase in size of the device is unavoidable in order to improve the performance of the optical demultiplexer using the diffraction grating. To solve this problem, an optical element, which can generate larger angular change based on the wavelengths than the diffraction grating, is required. Photonic crystal having a structure in which dielectrics different in refractive index are arranged periodically at intervals of a period substantially equal to the wavelength of light is an optical element exhibiting larger wavelength dispersion than the diffraction grating. It is well known that photonic crystal has the following properties:

(a) confinement of light due to a photonic band gap;

(b) very large wavelength dispersion due to a unique photonic band structure; and

(c) abnormality in group velocity of propagated light.

A large number of optical elements using such properties have been proposed or examined.

Such photonic crystals can be classified into one-dimensional photonic crystals, two-dimensional photonic crystals and three-dimensional photonic crystals by the number of directions having periodic structures. For example, the simplest one-dimensional photonic crystal is a multilayer filter formed in such a manner that two kinds of dielectric thin films (SiO₂ films and TiO₂ films) are laminated alternately on a parallel-plane substrate. The multilayer filter has been already put into practical use. This structure has a function of reflecting only input light in a specific wavelength range because it has a photonic band gap in a periodic direction. In addition, because the wavelength range of the photonic band gap for oblique input light varies in accordance with the direction of polarization, the multilayer filter can be provided to function as a polarized light separating filter.

A structure formed by application of photolithography in such a manner that air holes are arranged in thin films on a substrate has been examined widely and deeply as the two-dimensional photonic crystal. If a linear defect is formed in the arrangement of air holes, the portion of the linear detect can be provided as a waveguide.

In the three-dimensional photonic crystal, a steric waveguide can be achieved if a photonic band gap is achieved in all directions. There is therefore expectation that a large number of optical elements will be integrated into an element about 1 mm cube.

Of the one-dimensional, two-dimensional and three-dimensional photonic crystals, the one-dimensional photonic crystals have been not investigated so sufficiently as the two-dimensional and three-dimensional photonic crystals because the way to make the best use of the properties of the one-dimensional photonic crystals are almost limited to the multilayer filters though the one-dimensional photonic crystals has a large merit that the one-dimensional photonic crystals can be produced easily. Vary large wavelength dispersion due to the unique photonic band structure of the one-dimensional photonic crystals, however, can be utilized sufficiently. As means using the very large wavelength dispersion, there is an example in which an end surface of a multilayer film, that is, a surface having a multilayer structure exposed is used as a light input surface or a light output surface.

According to the present inventors' examination, it has become clear that light substantially perpendicularly incident onto an end surface of a multilayer film is propagated in an aperiodic direction so that the characteristic of a spectroscopic element using photonic crystal can be brought out (Japanese Patent Application No. 2001-266715).

As will be described later, in accordance with the inventors' electromagnetic wave simulations, it has been found that when plane wave of monochromatic light is made substantially perpendicularly incident onto an end surface of a one-dimensional photonic crystal (periodic multilayer film), the light is separated into waves corresponding to some photonic bands so that the waves are propagated through the multilayer film. When the wavelength of the input light is sufficiently long compared with the period of the multilayer film, only a wave corresponding to the first band (hereinafter referred to as “first band light”) is propagated. As the wavelength of the input light becomes shorter, high-order waves such as third band light and fifth band light begin to propagate successively. Accordingly, a part of energy of the input light always propagates as first band light regardless of the wavelength of the input light.

The high-order band light such as third band light or fifth band light exhibits very large wavelength dispersion resulting from the unique band structure whereas the first band light exhibits small wavelength dispersion undesirably. Accordingly, the first band light is wasteful light which is almost useless for a spectroscopic element. There is a possibility that the first band light may serve as stray light for worsening the signal-to-noise ratio of the element as well as the first band light may reduce the efficiency in use of input light.

### SUMMARY OF THE INVENTION

The invention is developed to solve the problem and an object of the invention is to provide an optical element exhibiting highly efficient spectroscopic properties by using only high-order band light, and to provide a spectroscopic device using the optical element.

In the invention, light incident onto an end surface of one-dimensional photonic crystal is phase-modulated in the same period and direction as those of the photonic crystal to thereby propagate only specific high-order band light through the photonic crystal. As a result, the intensity of light output from a surface of the one-dimensional photonic crystal used as a spectroscopic device is increased, that is, efficiency in use of input light is improved. Moreover, by the function of a structure added to the photonic crystal, output light is distributed into one side or opposite sides of the photonic crystal and the intensity of the output light is adjusted.

The function is achieved by the following optical element.

An optical element according to the invention includes a multilayer structure containing a periodic structure as at least one region, the periodic structure being regarded as one-dimensional photonic crystal having repetition of a predetermined period, wherein an end surface of the multilayer structure substantially perpendicular to layer surfaces of the multilayer structure is used as a light input surface. The optical element further includes a phase modulation unit disposed adjacent or abutting to the light input surface for generating phase-modulated wave having the same period as the period of the periodic structure in a laminating direction of the multilayer structure. One or each of two surfaces of the multilayer structure substantially parallel to layer surfaces of the multilayer structure is used as a light output surface.

Reversely, a surface of the multilayer structure substantially parallel to layer surfaces of the multilayer structure may be used as a light input surface while an end surface of the multilayer structure substantially perpendicular to layer surfaces of the multilayer structure may be used as a light output surface.

The optical element may be formed to satisfy the condition:

0<ks·λ₀/(2π·ns₂)<1

in which λ₀ is the wavelength of light in a vacuum when the light is incident onto the optical element, ks is the magnitude of a wave vector in a coupled photonic band (which is not the lowest) of the photonic crystal in the direction parallel to the layer surfaces in accordance with the wavelength λ₀, and ns₁ and ns₂ (ns₂≦ns₁) are refractive indices of media, respectively, coming into contact with opposite surfaces of the multilayer structure. In this case, output light is generated on opposite sides of the multilayer structure.

The optical element may be formed to satisfy the conditions:

0<ks·λ₀/(2π·ns₁)<1, and

1<ks·λ₀/(2π·ns₂)

In this case, output light is generated only on the side of the medium having a refractive index ns₁.

A second periodic structural portion may be provided between the periodic structural portion and a medium having a refractive index ns satisfying the condition:

0<ks·λ₀/(2π·ns)<1

By the second periodic structural portion, the intensity of output light on the medium side can be reduced.

A reflecting layer may be provided between the periodic structural portion and a medium having a refractive index ns satisfying the condition:

0<ks·λ₀/(2π·ns)<1

By the reflecting layer, output light can be restrained from being generated on the medium side. Preferably, the reflecting layer is constituted by a periodic structural portion different from the periodic structural portion of the photonic crystal.

Another aspect of the invention is as follows:

An optical device comprising:

a multilayer structure containing a periodic structure having repetition of a predetermined period in a laminating direction thereof, the multilayer structure having a first end surface substantially perpendicular or parallel to layer surfaces of the multilayer structure and a second end surface substantially perpendicular to the first end surface of the multilayer structure;

a light providing means for providing light to the multilayer structure;

a phase modulation unit for generating phase-modulated wave having a period the same as the period of the periodic structure; and

wherein the phase modulation unit is disposed between the multilayer structure and the light providing unit and

the light provided by the light providing means is output from the second end surface of the multilayer structure.

Specifically, an optical device functioning as a spectroscopic device can be formed by using an optical element constituted by the multilayer structure, an input unit for inputting light flux at mixed wavelengths into an end surface of the periodic structural portion of the multilayer structure and a detecting unit for detecting light rays output at different angles according to the wavelengths from a light output surface of the multilayer structure.

Further, an optical device functioning as an external resonator-including laser oscillator can be formed by using an optical element constituted by the multilayer structure, a semiconductor laser optically coupled to the optical element and a reflecting mirror for reflecting light output from the optical element to return the light to the optical element.

### BRIEF DESCRIPTION OF THE DRAWINGS

FIG. 1 is a typical view showing propagation of light in a periodic multilayer film;

FIG. 2 is a graph showing the photonic band structure (TE polarization) of the periodic multilayer film;

FIG. 3 is a graph showing the photonic band structure (TM polarization) of the periodic multilayer film;

FIG. 4 is a view showing propagation in a periodic multilayer film sandwiched between two kinds of homogeneous media;

FIG. 5 is a typical view showing refraction in a boundary between homogeneous media;

FIG. 6 is a typical view showing refraction of the coupled band propagated light;

FIG. 7A is a typical view showing electric field in the first band propagated light; and FIG. 7B is a typical view showing electric field in the coupled band propagated light.

FIG. 8 is a typical view showing light propagated in a periodic multilayer film provided with a phase grating;

FIG. 9 is a view showing various kinds of parameters in Calculation Examples;

FIG. 10 is a view showing a configuration in which a reflecting layer is disposed on the substrate side of the periodic multilayer film;

FIG. 11 is a view showing a configuration in which a second multilayer film is disposed on the substrate side of the periodic multilayer film;

FIG. 12 is a view showing a configuration in which second and third multilayer films are disposed on opposite sides of the periodic multilayer film;

FIG. 13 is a typical view showing an embodiment in the case where refracted light is taken out on the substrate side;

FIG. 14 is a typical view showing another embodiment in the case where refracted light is taken out on the substrate side;

FIG. 15 is a typical view showing a further embodiment in the case where refracted light is taken out on the substrate side;

FIG. 16 is a view showing an embodiment of configuration of a plane optical circuit according to the invention;

FIG. 17 is a view showing a simulation result in Calculation Example 1;

FIG. 18 is a view showing another simulation result in Calculation Example 1;

FIG. 19 is a graph for comparing band calculation with the simulation results in Calculation Example 1;

FIG. 20 is a view showing a simulation result in Comparative Calculation Example 1;

FIG. 21 is a view showing a simulation result in Calculation Example 2;

FIG. 22 is a graph for comparing band calculation with the simulation result in Calculation Example 2;

FIG. 23 is a view showing a simulation result in Calculation Example 3;

FIG. 24A is a typical view showing a main portion of a spectroscopic device as an applied example of the invention; and FIG. 24B is a typical view showing a photo acceptance optical system of the spectroscopic device; and

FIG. 25 is a typical view showing an external resonator-containing variable wavelength laser device as an applied example of the invention.

### DETAILED DESCRIPTION OF THE PREFERRED EMBODIMENTS

Embodiments of the invention will be described below specifically.

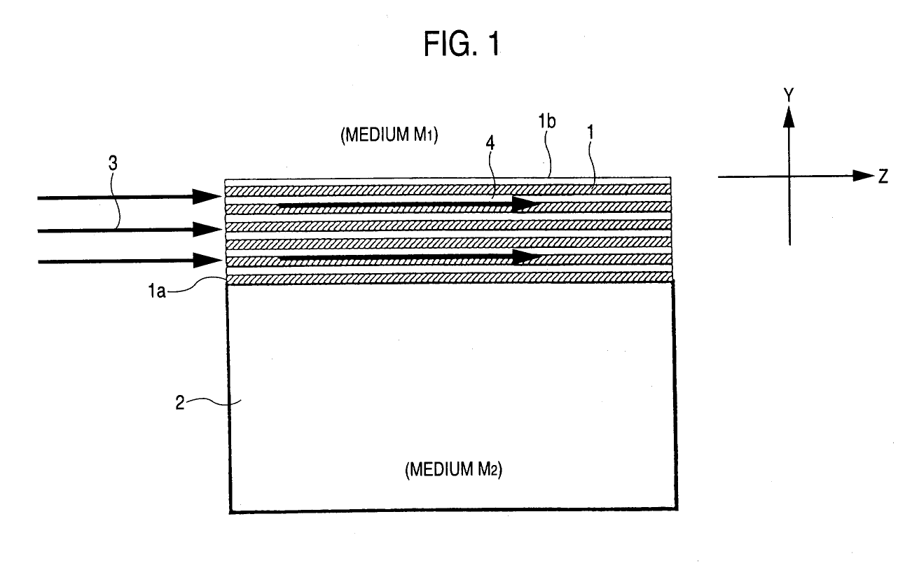

FIG. 1 is a sectional view typically showing a periodic multilayer film forming a basic structure according to the invention. A periodic multilayer film 1 is formed on a surface of a parallel plane substrate 2 (made of a medium M₂). For example, the multilayer film has a structure in which layers of a substance A with a thickness t_{A} (refractive index n_{A}) and layers of a substance B with a thickness t_{B} (refractive index n_{B}) are laminated alternately at intervals of a period a (=t_{A}+t_{B}). A surface of the multilayer film adjoins a medium M₁ (e.g., air in FIG. 1).

When light flux 3 at a wavelength λ₀ in a vacuum is made incident onto an end surface 1a of the periodic multilayer film in FIG. 1, how the light propagates in the multilayer film is analyzed. It is found from the analysis that the periodic myltilayer film functions as so-called photonic crystal to make the propagated light exhibit a unique effect in a predetermined condition.

The characteristic of light propagated through photonic crystal can be known when photonic bands are calculated and mapped out. For example, a method of calculating the bands has been described in detail in “Photonic Crystals”, Princeton University Press (1995) or Physical Review B Vol.44, No.16, p.8565, 1991.

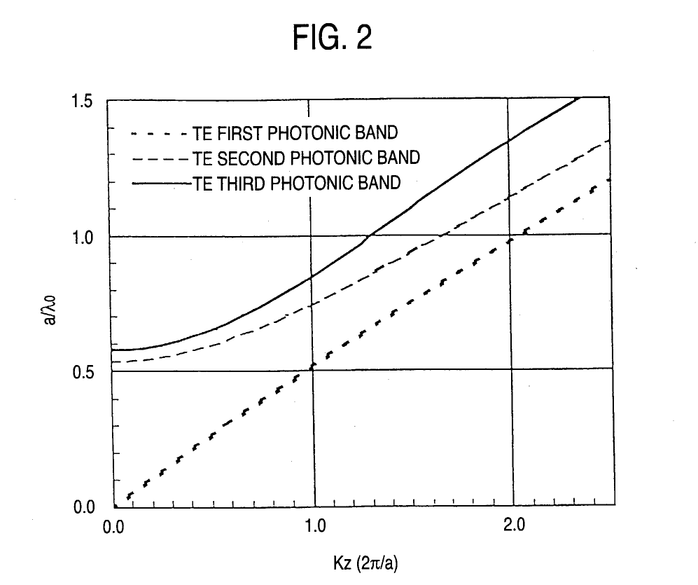

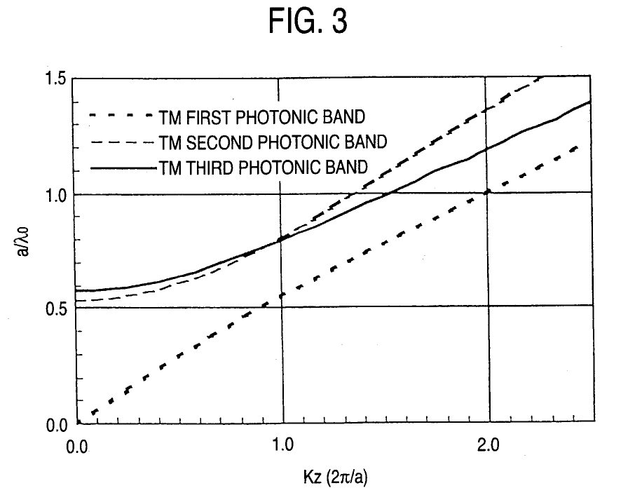

Assume that the periodic multilayer film shown in FIG. 1 has a periodic structure continued endlessly in a Y direction (laminating direction) and spreads endlessly in X and Z directions (spreading directions of layer surfaces). FIGS. 2 and 3 show first, second and third bands of TE polarization (FIG. 2) and TM polarization (FIG. 3) calculated in the Z-axis direction (or the X-axis direction) by a plane wave method in the case where a multilayer structure in which layers having the following refractive indices n_{A} and n_{B} are laminated alternately at intervals of a period a.

n_{A}=1.44(t_{A}=0.5a)

n_{B}=2.18(t_{B}=0.5a)

The term “TE polarization” means polarization in the case where the direction of electric field is the X-axis direction whereas the term “TM polarization” means polarization in the case where the direction of magnetic field is the X-axis direction.

In each of FIGS. 2 and 3, the horizontal axis shows the magnitude of a wave vector ks in the Z-axis direction, and the vertical axis shows the standardized frequency:

ωa/2πc

in which ω is the angular frequency of the input light, a is the period of the structure, and c is the velocity of light in a vacuum. The standardized frequency can be also given by a/λ₀ in which λ₀ is the wavelength of the input light in a vacuum. The standardized frequency is hereinafter referred to as a/λ₀. Because there is no periodicity in the Z-axis direction, a Brillouin zone spreads endlessly without any boundary in the horizontal axis in each of FIGS. 2 and 3.

As shown in FIG. 2, a wave vector k_{A1} corresponding to the first band is present in the photonic crystal when the wavelength of the input light in a vacuum is λ_{A}. In other words, a wave at the following wavelength (hereinafter referred to as “first band light”):

λ_{A1}=2π/k_{A1}

is propagated through the photonic crystal in the Z-axis direction.

On the other hand, when the wavelength of the input light in a vacuum is λ_{B}, there are wave vectors k_{B1} and k_{B3} corresponding to the first and third bands. The second band is ignored because it is an “uncoupled band”. Accordingly, the first band light at a wavelength λ_{B1}=2π/k_{B1} and a wave at a wavelength λ_{B3}=2π/k_{B3} (hereinafter referred to as “third band light”) are propagated through the photonic crystal in the Z-axis direction. Incidentally, the theory of uncoupled bands has been described in detail in the paper: K. Sakoda “Optical Properties of Photonic Crystals” Springer-Verlag (2001). The second and third bands appear in pair. One is “coupled band”, and the other is “uncoupled band”. In case of FIG. 2, the second band is uncoupled and the third band is coupled.

Here, a numerical value obtained by dividing a wavelength (λ_{A}, λ_{B}, etc.) in a vacuum by a corresponding wavelength (λ_{A1}, λ_{B3}, etc.) in photonic crystal is defined as “effective refractive index”. As is to be understood from FIGS. 2 and 3, the effective refractive index for the first band light is approximately unchanged regardless of the change of λ₀ because a/λ₀ (the vertical axis) is nearly proportional to ks (the horizontal axis). The effective refractive index for the second and third band light, however, varies widely in accordance with λ₀, so that the effective refractive index may become lower than 1 as is obvious from FIGS. 2 and 3.

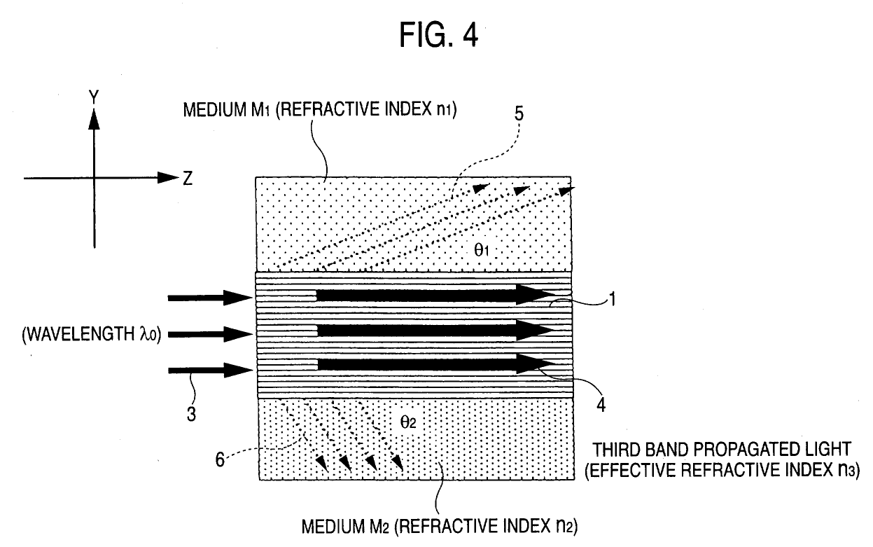

FIG. 4 shows the third (coupled) band propagated light (effective refractive index: n₃) in the Z-axis direction and media M₁ (refractive index: n₁) and M₂ (refractive index: n₂) adjoining opposite surfaces of the periodic multilayer structure in the case where input light at the wavelength λ₀ is perpendicularly incident onto an end surface of the periodic multilayer structure.

When beam 3 at the wavelength λ₀ in a vacuum is made incident onto an end surface of the multilayer film 1, a part of the light forms guided light 4 in the inside of the multilayer film 1 and a part of the light forms refracted light 5 on the medium M₁ side or refracted light 6 on the medium M₂ side. The directions (angles θ₁ and θ₂) of the refracted light rays 5 and 6 are substantially constant with respect to the wavelength λ₀, so that each of the refracted rays 5 and 6 is provided as ray bundle with very good directivity. In addition, because the values of θ₁ and θ₂ vary largely according to the change of the wavelength λ₀, the optical element can be used as a spectroscopic element with high resolving power.

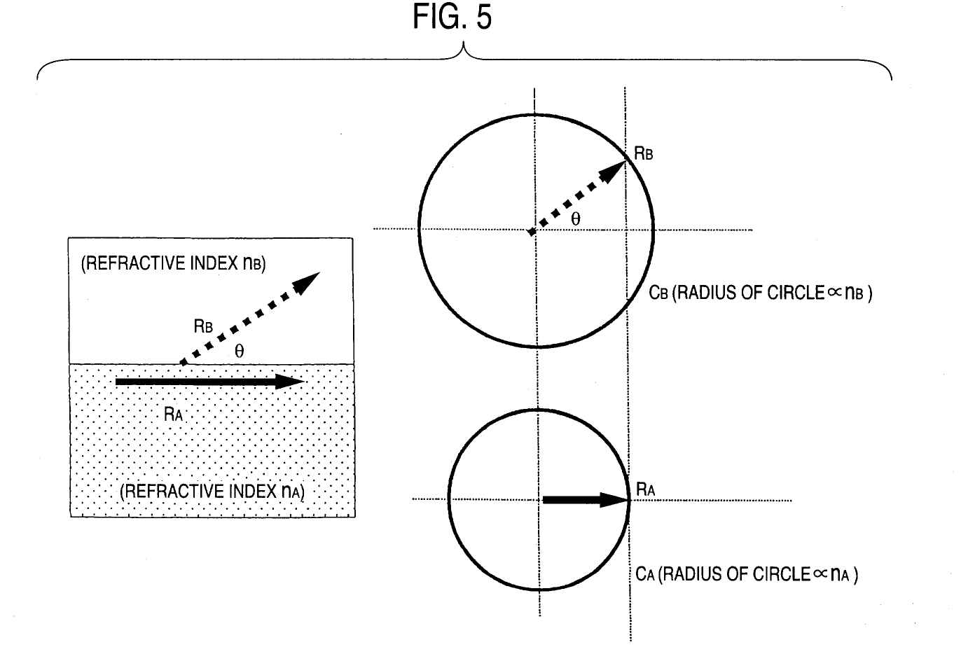

A method in which refraction of light in a boundary between two media homogeneous in terms of refractive index is expressed in a chart will be described with reference to FIG. 5. Rays R_{A} advancing near the medium A side boundary surface between the homogeneous medium A with refractive index n_{A} and the homogeneous medium B with a refractive index n_{B} (n_{A}<n_{B}) and in parallel to the boundary surface are released as refracted ray R_{B} at an angle θ toward the medium B side. The angle θ can be determined on the basis of a chart using two circles C_{A} and C_{B} with radii proportional to n_{A} and n_{B} respectively.

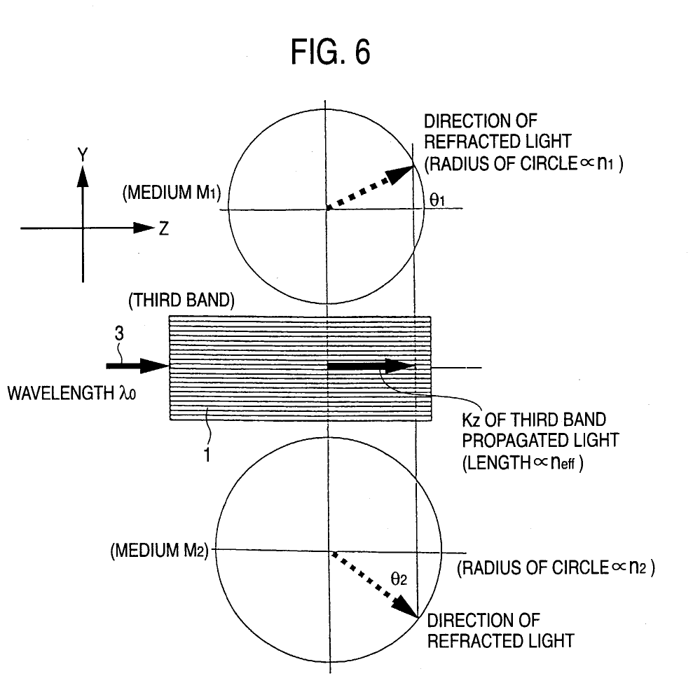

Also in the case of a periodic multilayer film, angles θ₁ and θ₂ of refraction can be determined on the basis of a chart (FIG. 6) drawn by use of effective refractive index neff in the same manner as described above. If n₃ is higher than n₁ and higher than n₂, the third band propagated light can be confined in the inside of the multilayer film 1 by total reflection in the boundary. As a result, propagation of the third band propagated light is continued in the inside of the multilayer film 1 because the third band propagated light cannot go out to the M₁ and M₂ sides.

Although the first band light brings wavelength dispersion to the same degree as in a general homogeneous medium, the third band light exhibits very large wavelength dispersion because the effective refractive index varies widely in accordance with the wavelength of the input light as described above. This is a kind of so-called super-prism effect. The super-prism effect has been proposed in Physical Review B, Vol.58, No.16, p.R10096, 1998.

Though not shown in FIGS. 2 and 3, the fourth or higher-order band exhibits large wavelength dispersion. A low-order band such as the second band or the third band is, however, preferably used because the number of “nodes” which will be described later increases in the high-order bands. Because it is however impossible to use any “uncoupled” band as described above, the preferred band is a “second coupled band from the lowest band”. In FIGS. 2 and 3, the third band is equivalent to the second coupled band.

Because the periodic multilayer film shown in FIG. 1 has a large difference between the structure in the X-axis direction and the structure in the Y-axis direction, the effective refractive index varies in accordance with the direction of polarization. This is obvious from the fact that the graph of TE polarization in FIG. 2 is different from the graph of TM polarization in FIG. 3. Accordingly, light propagated through the periodic multilayer film has a function of separating polarized light. For example, the periodic multilayer film may be used so that both demultiplexing and separation of polarized light according to wavelengths can be performed simultaneously. Accordingly, functions as provided by a combination of a diffraction grating and a polarized light separating element can be achieved by a single element, so that an optical system can be simplified.

In the case of one-dimensional photonic crystal, however, the difference between TE and TM in a high-order band (second or higher-order band) in a region in which ks is small (in a region close to the vertical axis in FIGS. 2 and 3) is very small, so that polarizing characteristic in this region can be substantially ignored.

As shown in FIG. 6, refracted rays can be taken out from opposite sides of the multilayer film 1. When the refractive index of the medium M₁ is lower than that of the medium M₂, the mode of refraction can be classified into the three conditions:

(1) refracted rays are generated on neither M₁ side nor M₂ side;

(2) refracted rays are generated on only the M₂ side; and

(3) refracted rays are generated on both M₁ and M₂ sides.

If refracted rays need to be concentrated in a single side, the condition (2) must be selected. If refracted rays need to be used in both sides individually, the condition (3) must be selected. It is a matter of course that refracted rays equal to each other in terms of angle of refraction can be taken out from both sides if the two media are made of one substance.

Specifically, when the refractive indices of the media M₁ and M₂ are n₁ and n₂ respectively (n₁≦n₂), the condition (2) can be obtained if the following relations are satisfied.

0<ks·₀/(2π·n₂)<1, and

1<ks·λ₀/(2π·n₁)

The condition (3) can be obtained if the following relations are satisfied.

0<ks·λ₀/(2π·n₁)<1, and

0<ks·λ₀/(2π·n₂)<1

According to the inventors' simulation, particularly intensive refracted rays can be obtained when the angle θ of refraction is in a range of from 20° to 60°. Accordingly, it is further preferable that the following condition for setting the angle of refraction in a range of from 20° to 60° is satisfied.

cos 60°<ks·λ₀/(2π·n)≦cos 20°

in which n means ns₁ or ns₂.

As described above, very large wavelength dispersion can be obtained when a high-order propagated light is used. As is obvious from FIGS. 2 and 3, the first band light, however, always propagates, for example, when the third band light propagates. Because the first band propagated light has little wavelength dispersion effect as described above, the first band light is no more than loss when the third band propagated light is used. The first band light serves stray light causing lowering of the signal-to-noise ratio of the element as well as it causes great reduction in efficiency in use of incident light energy.

According to the inventors' examination, only high-order band propagated light such as the third band light can be however propagated through the periodic multilayer film when the input light is phase-modulated.

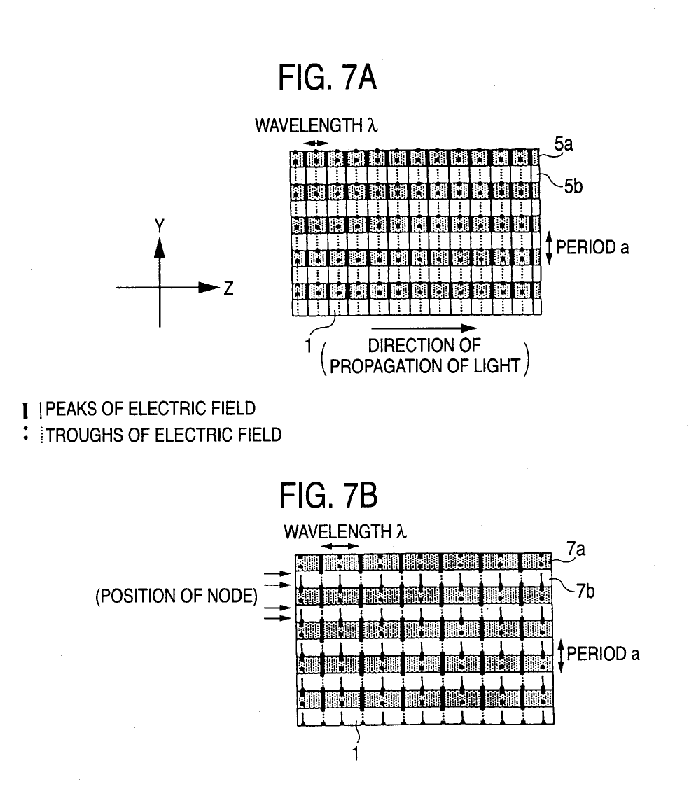

FIGS. 7A and 7B typically show the intensity of electric field due to the first band propagated light and the third (coupled) band propagated light in the Z-axis direction in a periodic multilayer film (period a) provided as a laminate of alternate substances A and B. In FIGS. 7A and 7B, the solid lines show peaks of electric field, the broken lines show troughs of electric field, and the thickness of each line shows the magnitude of the amplitude.

With respect to the first band propagated light, as shown in FIG. 7A, the amplitude of the electric field in the medium A is different from that in the medium B but peaks and troughs of the electric field are formed in respective planes perpendicular to the Z axis. Hence, the first band light propagates as nearly plane wave.

With respect to propagated light due to the second coupled band from the lowest band (i.e., the third band in this case), however, as shown in FIG. 7B, “nodes” in which the amplitude of the electric field is zero are produced so that one structural period in the Z direction is divided into two regions. Because adjacent regions differ in the phase of wave by a half wavelength, peaks and bottoms appear alternately. Though not shown, in propagated light due to a higher-order band, the number of nodes in one period increases so that the half-wavelength shift occurs frequently in one period.

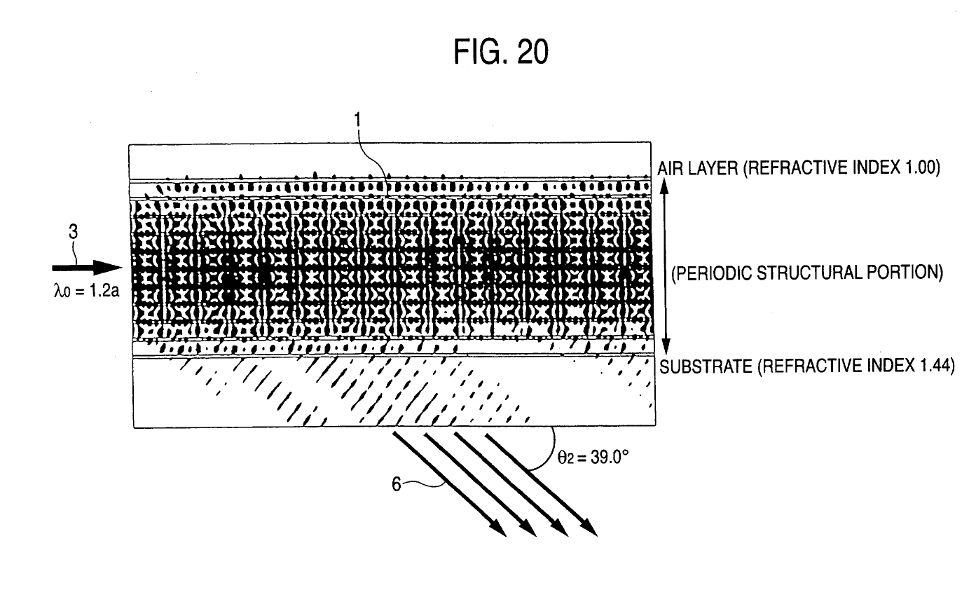

Accordingly, two kinds of propagated light due to input light at a wavelength (e.g., λ_{B} in FIG. 2) related to both the first and third bands overlap each other, so that a complex electric field pattern is exhibited (FIG. 20 shows this example).

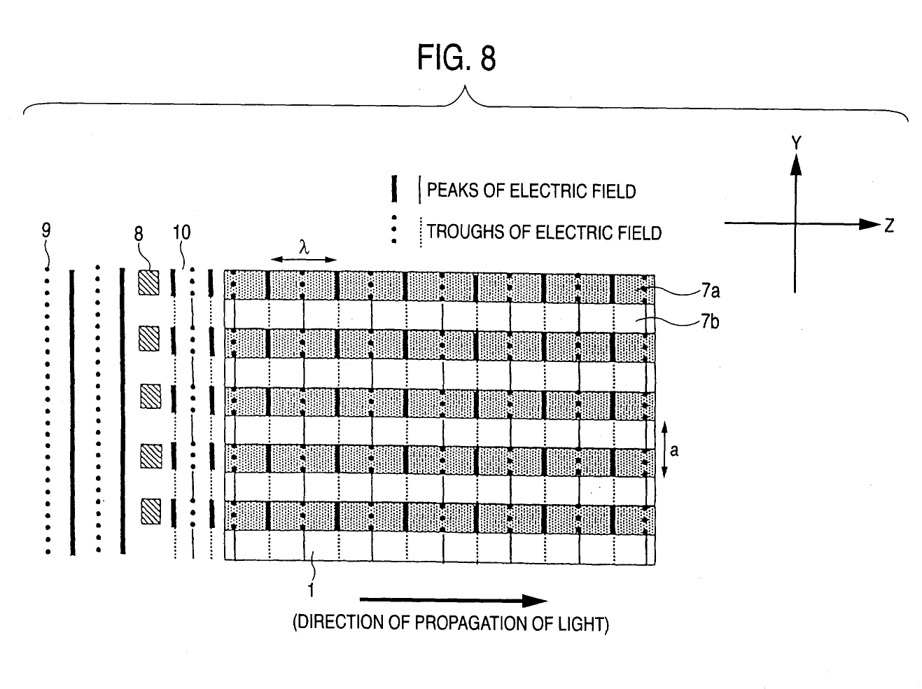

Incidentally, when plane wave 7 is imported into a phase grating 8 for generating a difference of approximately a half wavelength in a period a in the Y direction as shown in FIG. 8, an electric field pattern similar to that of the third band propagated light in FIG. 7B can be produced in a space 10. It has become clear from the inventors' simulation that only the third band propagated light can be generated without generation of the first band propagated light when an end surface of the periodic multilayer film 1 is disposed in this space 10. The fact that “only propagated light belonging to a specific high-order band can be obtained when appropriate phase-modulated wave having a period a in the periodic direction of a multilayer film having a period a is imported into the multilayer film” can be generalized from this result.

The condition of the phase modulation unit will be described below specifically.

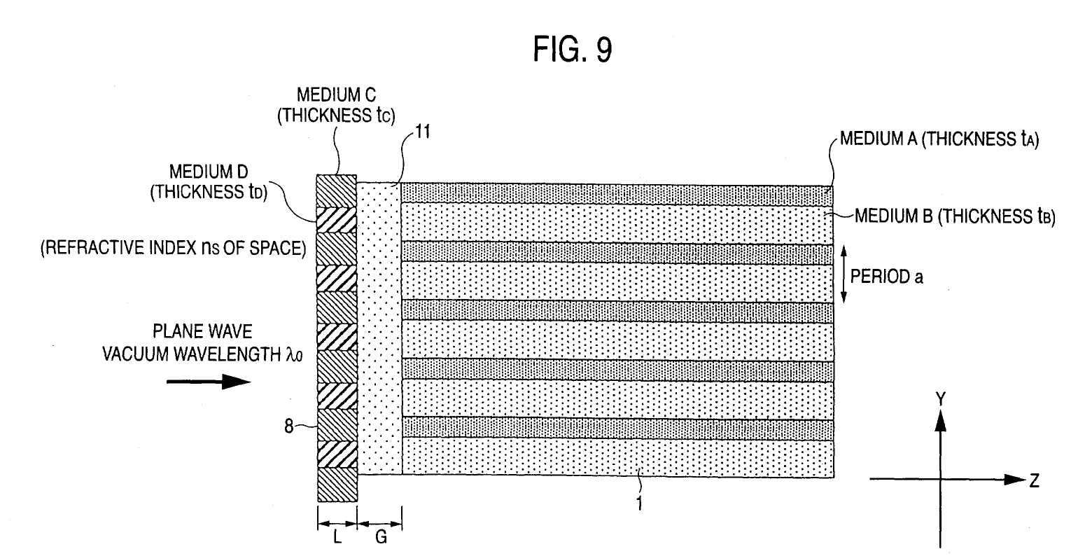

The simplest phase modulation unit is a phase grating 8 having the same period as that of the periodic multilayer film 1. Generally, the phase grating 8 as shown in FIG. 9 may be disposed. According to the inventors' simulation, it is necessary to optimize characteristic of phase modulation (such as values of thicknesses t_{C}, t_{D}, L, G, etc. in FIG. 9) in accordance with the characteristic of the periodic multilayer film 1, i.e., thickness ratio of layers, refractive indices of layers, etc. Because phase modulation needs to be synchronized with the period of the multilayer film, it is necessary to satisfy the following conditions:

(1) t_{A}+t_{B}=t_{C}+t_{D};

(2) the Y-direction center of the medium A being coincident with the Y-direction center of the medium C; and

(3) the Y-direction center of the medium B being coincident with the Y-direction center of the medium D.

Because the length of the space 11 between the phase grating 8 and the periodic multilayer film 1 also has influence on propagated light, the length of the space 11 must be selected to be in an optimum range. If the period a of the multilayer film is not larger than the wavelength λ₀ of light in a vacuum, diffracted light of the order of ±1 by the phase grating 8 cannot propagate when the gap between the phase grating 8 and the periodic multilayer film 1 is provided as an air layer. As a result, the amount of reflected light increases. To prevent increase in the amount of reflected light, there may be used a method of filling the space 11 of the gap with a medium having a high refractive index n_{G}. Specifically, it is preferable to satisfy the relation:

λ₀/n_{G}<a

For carrying out the invention, a method in which a groove is formed near an end surface of the periodic multilayer film so that a part of the multilayer film is directly used as a phase grating is more practical. This case is equivalent to the case where the following conditions are satisfied in FIG. 9.

(1) The medium A is equal to the medium C;

(2) The medium B is equal to the medium D;

(3) t_{A}=t_{C}; and

(4) t_{B}=t_{D}.

The thickness of the phase grating and the width of the groove must be adjusted so that only the third band light can propagate efficiently. The groove portion may be directly provided as an air layer or may be filled with a homogeneous medium in order to satisfy the aforementioned conditions.

When the periodic structural portion of the multilayer structure in the invention is made of two kinds of substances as shown in FIG. 1, it is the simplest. Improvement in dispersion and polarizing characteristic and improvement in efficiency in use of input light can be assisted when the average refractive index and the band structure are adjusted by the following means: (1) means for changing the thickness ratio between the two layers; (2) means for providing three or more layers; or (3) means for providing three or more kinds of film materials. Incidentally, the refractive indices and thicknesses of respective layers need to have predetermined periodicity.

Even in the case where each of layers constituting the multilayer film has a refractive index changing continuously, the characteristic of the multilayer film can be substantially kept constant if the refractive index difference is kept constant.

Generally, the periodic structural portion is constituted by a laminate of m kinds (in which m is a natural number) of substances. Assume now that n₁, n₂, . . . , nₘ are refractive indices of substances 1, 2, . . . , m constituting one period, and that t₁, t₂, . . . , tₘ are thicknesses of the substances 1, 2, . . . , m respectively. The average refractive index n_{M} per period of the multilayer structure in the used wavelength λ is defined by the equation:

n_{M}=(t₁·n₁+t₂·n₂+ . . . +tₘ·nₘ)/a

in which a is one period represented by the equation:

a=t₁+t₂+ . . . +tₘ

Only the first band is present (see FIGS. 2 and 3) when the average refractive index n_{M} of the periodic structural portion roughly satisfies the following relation.

a/λ₀≦0.5/n_{M}

Therefore, for use of the second or higher bands, the period a of the multilayer structure needs to satisfy the following relation for the used wavelength λ₀.

λ₀/2n_{M}≦a

If the period a is smaller than λ₀/2n_{M}, the characteristic of the multilayer structure becomes close to that of a homogeneous medium having the average refractive index because no light but the first band light is propagated.

As shown in Calculation Examples which will be described later, wave is particularly apt to be disordered if the multilayer film is too thin. It is therefore preferable that the number of periods in the multilayer film is selected to be not smaller than 10, especially not smaller than 15 if possible.

The material of the multilayer film used in the invention is not particularly limited if transparency can be obtained surely in the used wavelength range. For example, a material such as silica, silicon, titanium oxide, tantalum oxide, niobium oxide, or magnesium fluoride which is generally used as a multilayer film material and which is excellent in terms of durability and film-forming cost can be used preferably. The material can form a multilayer film easily by a well known method such as sputtering, vacuum vapor deposition, ion assist vapor deposition, or plasma CVD.

Because wavelength dispersion or the like has a tendency toward increase as the refractive index ratio of the multilayer film materials becomes higher, it is preferable that a high-refractive-index material and a low-refractive-index material are used in combination when such characteristic is required. When, for example, air (refractive index: 1) and InSb (refractive index: 4.21) are used as the low-refractive-index material and the high-refractive-index material respectively, a refractive index ratio of not lower than 4 can be achieved in practice (see “Micro-Optics Handbook” p.224, 1995, ASAKURA SHOTEN).

Because characteristic difference due to the direction of polarization has a tendency toward decrease as the refractive index ratio of the multilayer film materials becomes lower, a combination low in the refractive index ratio is also useful for achieving independence of polarization. Because the modulating function may be however weakened so that the expected function cannot be fulfilled when the refractive index ratio is too low, it is preferable that a refractive index ratio of not lower than 1.2 is ensured.

The groove provided near to an end surface of the multilayer film can be formed by the general method of application of a resist layer→patterning→etching→removal of the resist layer after the multilayer film is laminated. Air or vacuum in the groove portion may be used as the low-refractive-index material or the groove portion may be filled with a medium. As the material of the medium to be filled with, there can be used an organic resin, a sol-state glass material, a molten semiconductor material, etc. The sol-state glass material may be gelated and then heated to be provided as transparent glass.

If materials are selected appropriately, the function of the invention can be fulfilled in a wavelength range of from about 200 nm to about 20 μm used generally.

The material of the substrate for the multilayer film is not particularly limited if the refractive index of the material is in a range free from leakage of propagated light. Examples of the material preferably used are soda lime glass, optical glass, silica, silicon, and compound semiconductor such as gallium arsenide. If limitation due to temperature characteristic or the like is little, a plastic material may be used as the substrate material.

A so-called air bridge structure constituted by only the multilayer film without use of any substrate may be used.

As described above, when refracted light needs to be taken out on a single side of the multilayer structure and used, a low-refractive-index medium M₁ (an air layer) and a high-refractive-index medium M₂ (a substrate) may be provided as shown in FIG. 6. As the simplest configuration in this case, the period a of the periodic structure may be adjusted so that refracted light can be concentrated on the substrate side without generation of M₁ side refracted light. The effective refractive index of the multilayer film, however, must be higher than 1. When refracted light needs to be taken out only from a single side in the condition that the effective refractive index of the multilayer film is not higher than 1, it is therefore necessary to provide some reflecting layer between the multilayer film and one of the media.

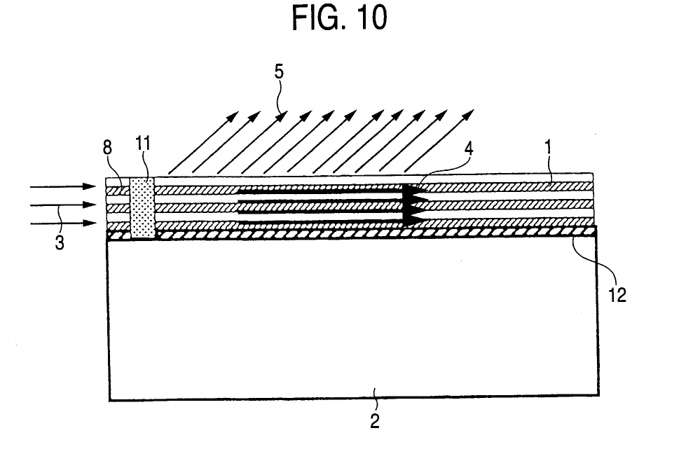

FIG. 10 shows a structure in which a reflecting layer 12 (e.g., a metal film) is disposed between the substrate 2 and the multilayer film 1. In this configuration, input light 3 incident onto the phase grating 8 is subjected to the function of the phase grating 8 and then imported into a surface of the multilayer film 1 substantially perpendicular to layer surfaces of the multilayer film 1 through the space 11. In the multilayer film 1, light 4 substantially constituted by only the third band light propagates efficiently in a direction parallel to layer surfaces. Refracted light 5 is concentrated and output only on the air side by the function of the reflecting layer 12.

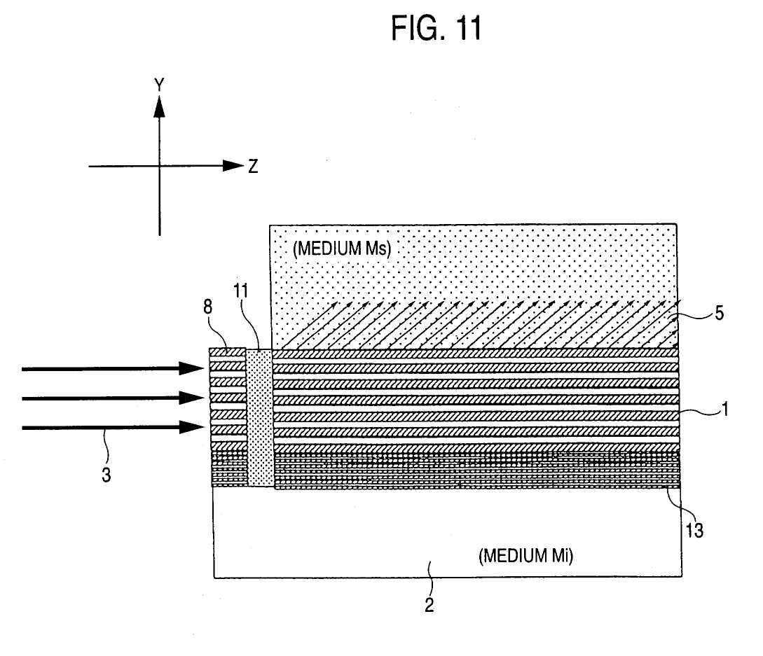

FIG. 11 shows a structure in which a second multilayer film 13 is disposed between the substrate 2 and the multilayer film 1. Other parts are referred to by numerals the same as those in FIG. 10 and the description thereof will be omitted (this rule applies hereunder). If a photonic band corresponding to any high-order band propagated light in the first multilayer film 1 is absent in the second multilayer film 13, the second multilayer film 13 has a function of confining propagated light.

A method in which the second multilayer film is made of the same material as that of the first multilayer film but is different in period or thickness ratio from the first multilayer film is the simplest in terms of simplification of the film-forming process. Specifically, for example, the period of the second multilayer film may be selected to be smaller than the period a of the first multilayer film so that the high-order band corresponding to the frequency of the propagated light can be eliminated. As shown in Calculation Examples which will be described later, the electric field of the propagated light oozes out as evanescent light into the second multilayer film. In order to ensure confinement, it is necessary to increase the thickness (i.e., the number of periods) of the second multilayer film to a certain degree.

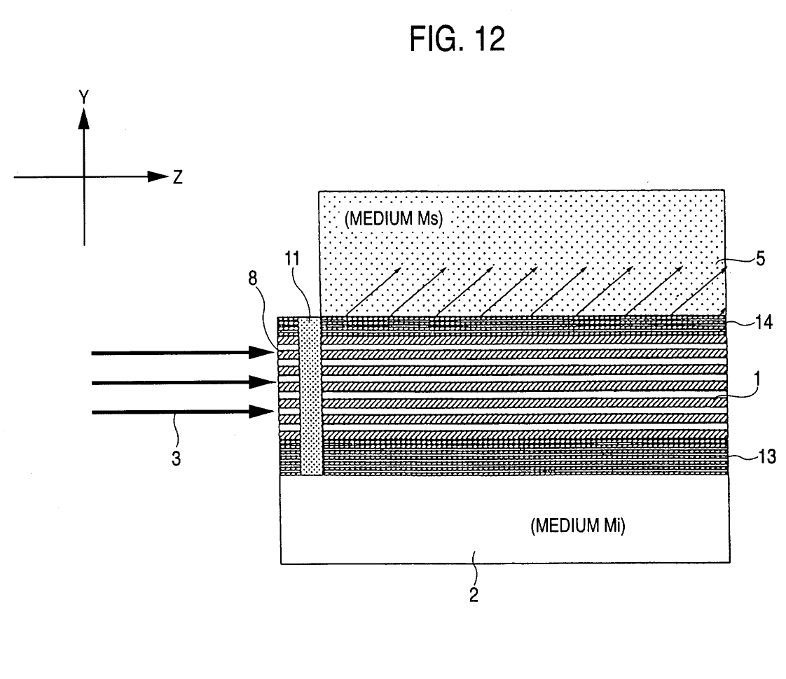

FIG. 12 shows the case where a third multilayer film 14 is disposed on a side in which refracted light 5 is taken out. The third multilayer film 14 is made a little thin (small in the number of periods). Accordingly, confinement of propagated light is so imperfect that the third multilayer film 14 has a function of weakening the intensity of refracted light 5. Because the total amount of refracted light is unchanged though the intensity of refracted light is weakened, the range of radiation of refracted light in the Z-axis direction is widened. Accordingly, because light flux of refracted light 5 becomes more thick to reduce spread due to diffraction, the third multilayer film 14 is effective in increasing wavelength resolving power.

Next, a method for taking out refracted light from a surface of the multilayer film will be described.

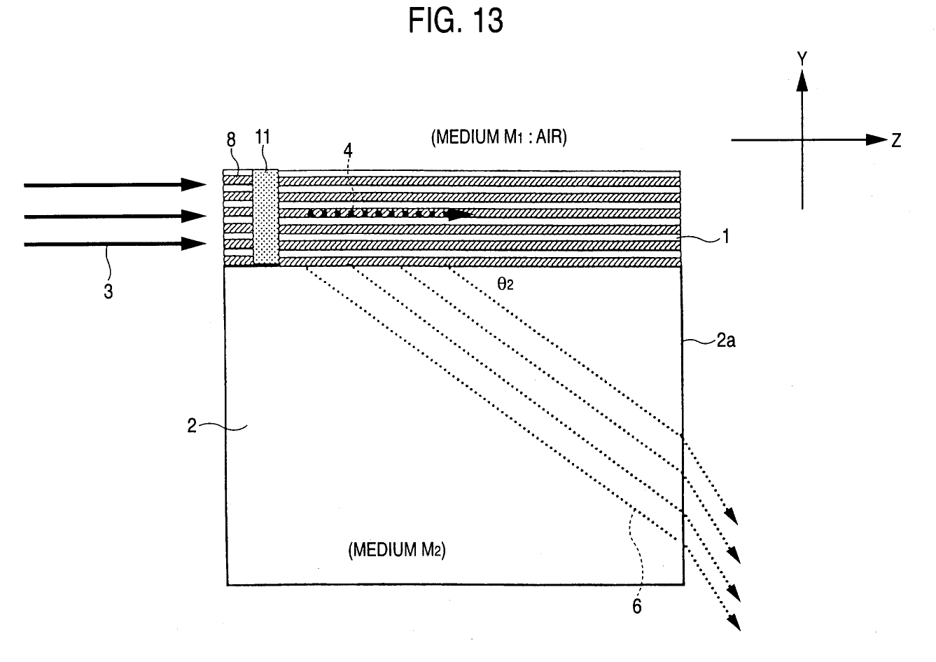

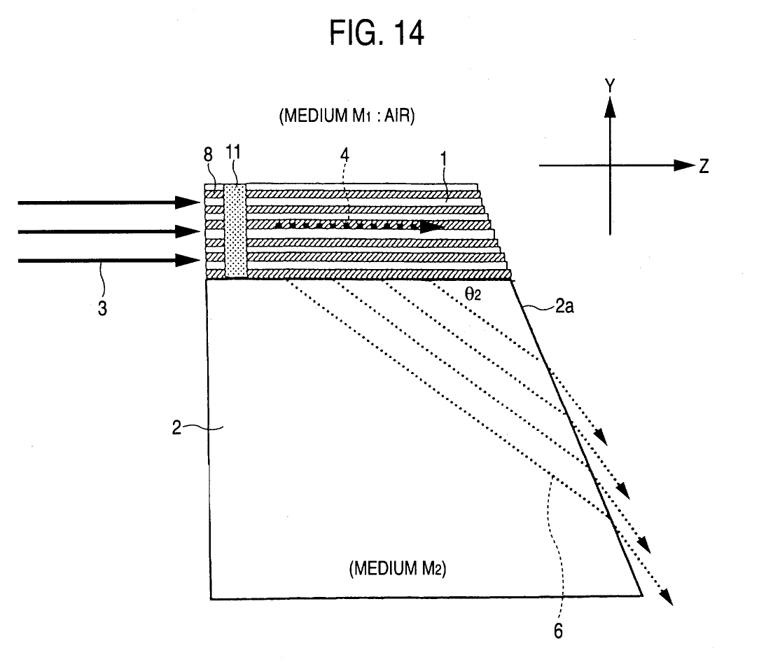

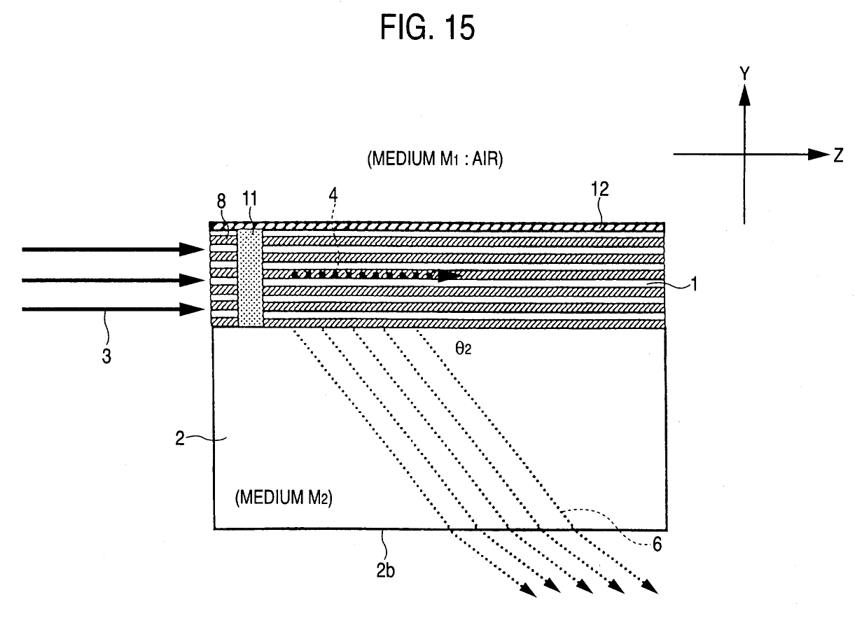

When refracted light needs to be taken out only on the substrate side, the interface between the substrate and the air may be used for forming configurations as shown in FIGS. 13 to 15. FIG. 13 shows the case where refracted light 5 on the substrate 2 side is further refracted by an end surface 2a of the substrate. In FIG. 13, the angular difference in wavelength dispersion in the air becomes larger than that in the substrate. FIG. 14 shows the case where the end surface 2a of the substrate is inclined so that wavelength dispersion in the air can be maximized. Also when a medium having an inclined surface is bonded to a parallel-plane substrate, the same effect as described above can be obtained. FIG. 15 shows the case where a reflecting layer 12 is provided on the air side surface of the same structure as in FIG. 13.

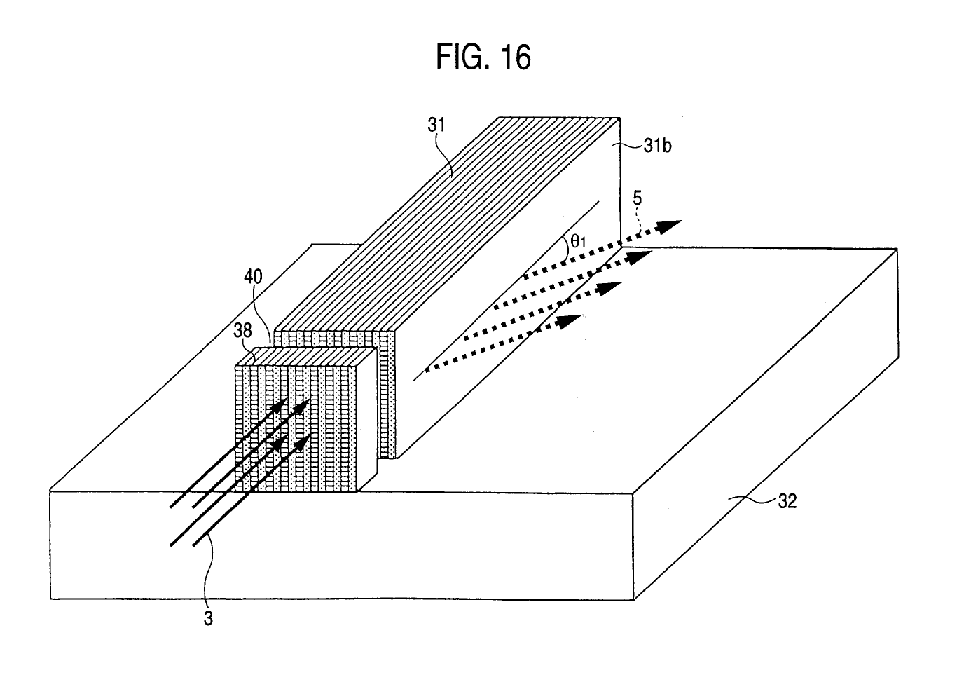

FIG. 16 shows an example in which the optical system is formed as a flat plate-like optical circuit so that optical processing can be performed only in a direction parallel to a surface of a substrate. A multilayer structure 31 having periodicity in a direction parallel to the substrate surface is formed on a plane substrate 32. When a groove 40 is formed in an end portion of the multilayer structure 31, a phase grating 38 can be provided. After input light 3 is propagated through the multilayer structure 31, refracted light 5 having an angle θ₁ dependent on the wavelength is output in parallel to the substrate 32 from a surface 31b of the multilayer structure 31.

As an example of the multilayer structure, there is used a structure in which deep grooves perpendicular to the substrate surface and parallel to one another are formed in a homogeneous substance on the substrate 32. In this case, air or vacuum in the groove portion may be used as a low-refractive-index material or the groove portion may be filled with any medium. As the material of the medium to be filled with, there can be used an organic resin, a sol-state glass material, a molten semiconductor material, etc. The sol-state glass material may be gelated and then heated to be provided as transparent glass.

The configuration of the invention may be used after input light and output light are replaced by each other. That is, in the case where input light with at the wavelength λ₀ in a vacuum is made incident onto a surface parallel to layer surfaces of the multilayer structure, light can be propagated in a direction parallel to layer surfaces of the multilayer structure so that output light can be obtained from an end surface substantially perpendicular to layer surfaces of the multilayer structure only when the input light is imported at a predetermined angle.

Specific configuration examples of the invention will be described below.

### CALCULATION EXAMPLES

Propagation and refraction of light in the inside of one-dimensional photonic crystal combined with a phase grating are simulated by a finite-element method. Results of the simulation are listed below. A software program used is JMAG made by THE JAPAN RESEARCH INSTITUTE, LIMITED.

A calculation model shown in FIG. 9 is used. The one-dimensional photonic crystal is formed to have a structure like a multilayer film 1 in which layers of a homogeneous medium A and layers of a homogeneous medium B are laminated alternately. Let a be one period in the multilayer film 1. Let t_{A}·a and t_{B}·a be the thickness of one medium A layer and the thickness of one medium B layer respectively. Let n_{A} and n_{B} be the refractive indices of the media A and B respectively. A phase grating 8 is disposed so as to be far by a distance G from a vertical section of the photonic crystal. A space 11 between the photonic crystal and the phase grating is filled with a homogeneous medium having a refractive index n_{G}.

One period in the phase grating 8 constituted by media C and D is equal to that in the multilayer film 1. Let t_{C}·a and t_{D}·a be the thickness of one medium C layer and the thickness of one medium D layer respectively. Let n_{C} and n_{D} be the refractive indices of the media C and D respectively. Let L be the length of the phase grating 8 in the direction of the Z axis.

A space with a refractive index ns is provided outside the phase grating 8. A plane wave (linearly polarized wave) exhibiting a wavelength λ₀ in a vacuum is perpendicularly incident onto the phase grating 8 through this space.

### Calculation Example 1

The structure shown in FIG. 9 was subjected to an electromagnetic wave simulation in the case where the wavelength of the input light is varied in conditions shown in Table 1. In the following calculation examples and comparative examples, all lengths were standardized with reference to the period a.

TABLE 1
<Configuration of Multilayer Film (Calculation Example 1)>

| | | Thickness of | Refractive |
|---|---|---|---|
| | Layer No. | Layer | Index |
| Air Layer | — | — | 1.00 |
| Periodic | 1 | 0.20a | 2.18 |
| Structural | 2 | 0.80a | 1.44 |
| Portion | 3 | 0.20a | 2.18 |
| | 4-21 | Repetition of | Repetition of |
| | | 0.80a and 0.20a | 1.44 and 2.18 |
| Substrate | — | — | 1.44 |

Thickness of the phase grating portion: L=0.811a

Gap between the phase grating and the incident surface of the multilayer film: G=0.80a

Refractive index of the space at the gap portion: n_{G}=1.44

Refractive index of the incidence side space: n_{S}=1.00

Conditions of incident light:

Vacuum wavelength: λ₀=1.2a, 1.3a

Polarization: TE polarization (the direction of electric field was the X-axis direction)

Plane wave equivalent to a beam waist of a Gaussian beam with a numerical aperture NA=0.1

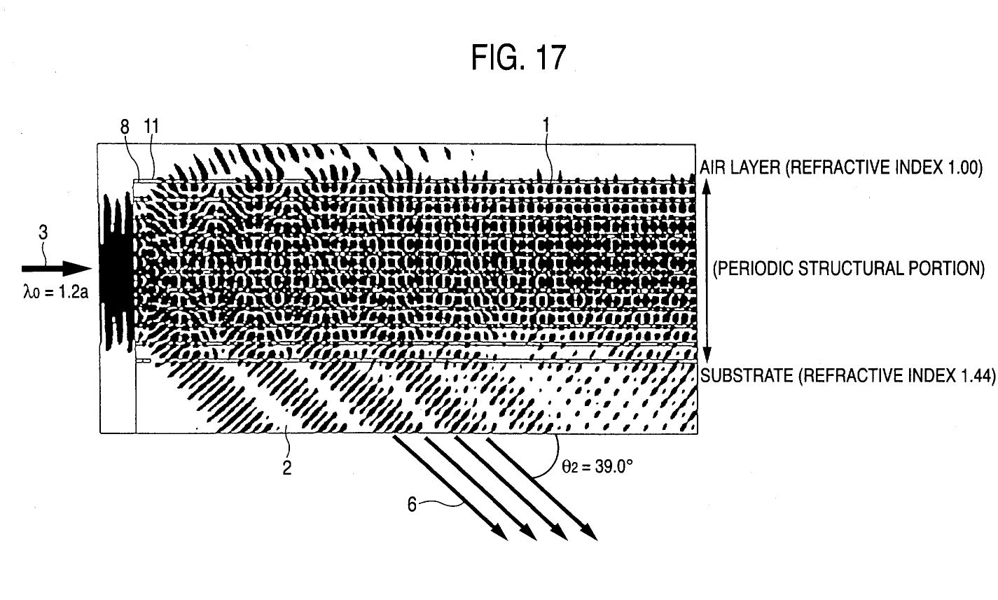

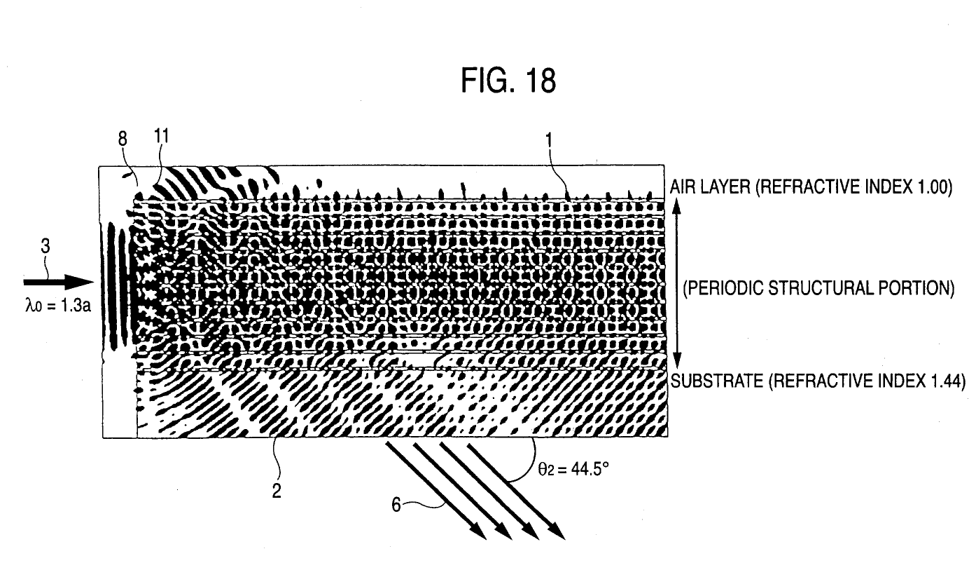

As results of the simulation, electric field intensity distributions and angles of refracted light are shown in FIG. 17 (in the case of λ₀=1.2a) and FIG. 18 (in the case of λ₀=1.3a). It is obvious that there is little first band propagated light because light propagated through the multilayer film 1 portion is made nodular and regular by the function of the phase grating 8. Because the effective refractive index for propagated light exhibits a value between 1.00 and 1.44, refracted light 6 is generated only on the substrate 2 side which is high in refractive index. Further, the angle θ₂ Of the substrate side refracted light 6 varies largely according to a slight wavelength difference in the input light 3.

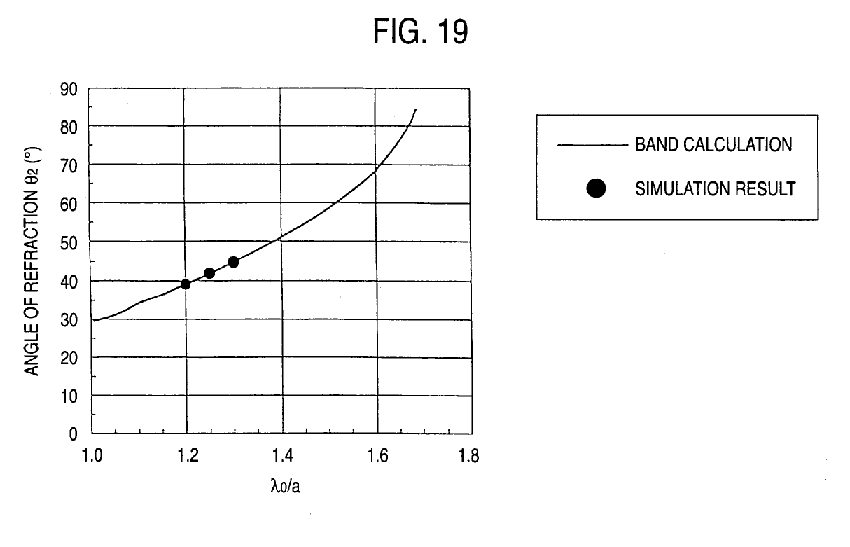

FIG. 19 shows simulation results about the change of the angle θ₂ of refraction in accordance with the incident light wavelength (λ₀/a) inclusive of another wavelength of the input light than the aforementioned wavelengths. The angular change of the substrate side refracted light 6 is about 0.69° per Δλ₀=1%. It is obvious that large wavelength dispersion is obtained.

Incidentally, the term “band calculation” used in FIG. 19 means a calculated value based on the effective refractive index obtained from a band chart according to a plane wave method.

### Comparative Calculation Example 1

FIG. 20 shows a simulation result in the case where the phase grating portion is removed from Calculation Example 1. Incidentally, the simulation result is shown only in the case where the vacuum wavelength λ₀ of the input light 3 is equal to 1.2a.

In FIG. 20, propagated light at a short wavelength due to the first band and propagated light at a long wavelength due to the third band overlap each other. Accordingly, the electric field pattern in FIG. 20 becomes more complex than that in FIG. 17. It is also obvious from comparison of FIG. 20 with FIG. 17 that the intensity of the refracted light 6 is reduced according to the reduced intensity of the third band propagated light.

### Calculation Example 2

This example shows the case where a second periodic structural portion 13 with a short period is disposed between the periodic multilayer film 1 and the substrate 2 to prevent refracted light from going out to the substrate 2 side. The configuration of the multilayer film is shown in Table 2.

TABLE 2
<Configuration of Multilayer Film (Calculation Example 2)>

| | | Thickness of | Refractive |
|---|---|---|---|
| | Layer No. | Layer | Index |
| Air Layer | — | — | 1.00 |
| Periodic | 1 | 0.80a | 1.44 |
| Structural | 2 | 0.20a | 2.18 |
| Portion | 3-24 | Repetition of | Repetition of |
| | | 0.80a and 0.20a | 1.44 and 2.18 |
| Second | 25 | 0.448a | 1.44 |
| Periodic | 26 | 0.112a | 2.18 |
| Structural | 27-44 | Repetition of | Repetition of |
| Portion | | 0.448a and | 1.44 and 2.18 |
| | | 0.112a | |
| Substrate | — | — | 1.44 |

Thickness of the phase grating portion: L=0.622a

Gap between the phase grating and the incident surface of the multilayer film: G=0.80a

Refractive index of the space at the gap portion: n_{G}=2.00

Refractive index of the incidence side space: n_{S}=1.00

Conditions of incident light:

Vacuum wavelength: λ₀=1.66a

Polarization: TE polarization (the direction of electric field was the X-axis direction)

Plane wave equivalent to abeam waist of a Gaussian beam with a numerical aperture NA=0.1

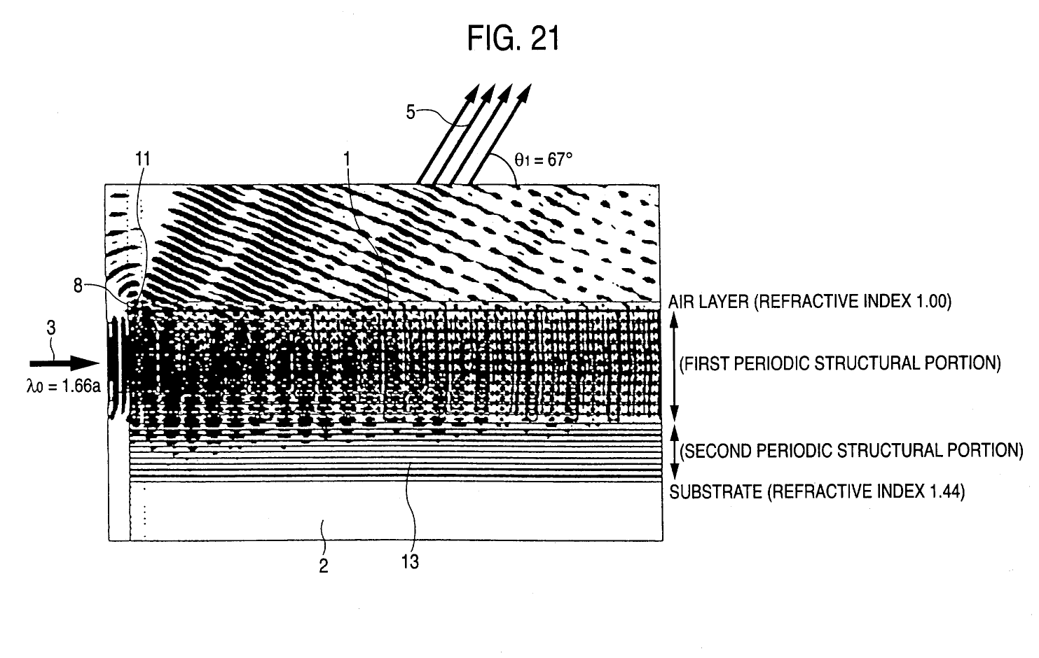

As a result of the simulation, an electric field intensity distribution in the case of λ₀=1.66a is shown in FIG. 21. The effective refractive index for propagated light is about 0.37 which is a value smaller than 1. Refracted light is little generated on the side of the substrate 2 by the second periodic structure 13, so that intensive refracted light 5 is generated on the air side.

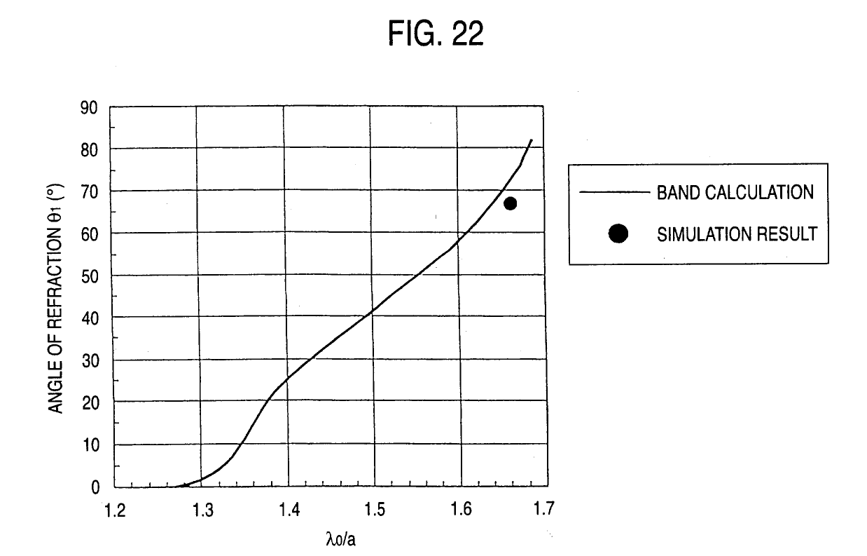

FIG. 22 shows a simulation result about the change of the angle θ₂ of refraction in accordance with the incident light wavelength (λ₀/a). The angular change of the air side refracted light 5 is about 3.1° per Δλ₀=1%. It is obvious that very large wavelength dispersion is obtained.

### Calculation Example 3

This example shows the case where a third periodic structural portion 14 with a short period is further disposed between the periodic multilayer film 1 and the air layer in addition to the configuration shown in Calculation Example 2 to weaken the intensity of refracted light on the air layer. The configuration of the multilayer film is shown in Table 3.

TABLE 3
<Configuration of Multilayer Film (Calculation Example 3)>

| | | Thickness of | Refractive |
|---|---|---|---|
| | Layer No. | Layer | Index |
| Air Layer | — | — | 1.00 |
| Third Periodic | 1 | 0.112a | 2.18 |
| Structural | 2 | 0.448a | 1.44 |
| Portion | 3-10 | Repetition of | Repetition of |
| | | 0.112a and | 2.18 and 1.44 |
| | | 0.448a | |
| Periodic | 11 | 0.20a | 2.18 |
| Structural | 12-35 | Repetition of | Repetition of |
| Portion | | 0.80a and 0.20a | 1.44 and 2.18 |
| Second | 36 | 0.448a | 1.44 |
| Periodic | 37 | 0.112a | 2.18 |
| Structural | 38-55 | Repetition of | Repetition of |
| Portion | | 0.448a and | 1.44 and 2.18 |
| | | 0.112a | |
| Substrate | — | — | 1.44 |

Thickness of the phase grating portion: L=0.622a

Gap between the phase grating and the incident surface of the multilayer film: G=0.800a

Refractive index of the space at the gap portion: n_{G}=2.00

Refractive index of the incidence side space: n_{S}=1.00

Conditions of incident light:

Vacuum wavelength: λ₀=1.66a

Polarization: TE polarization (the direction of electric field was the X-axis direction)

Plane wave equivalent to a beam waist of a Gaussian beam with a numerical aperture NA=0.1

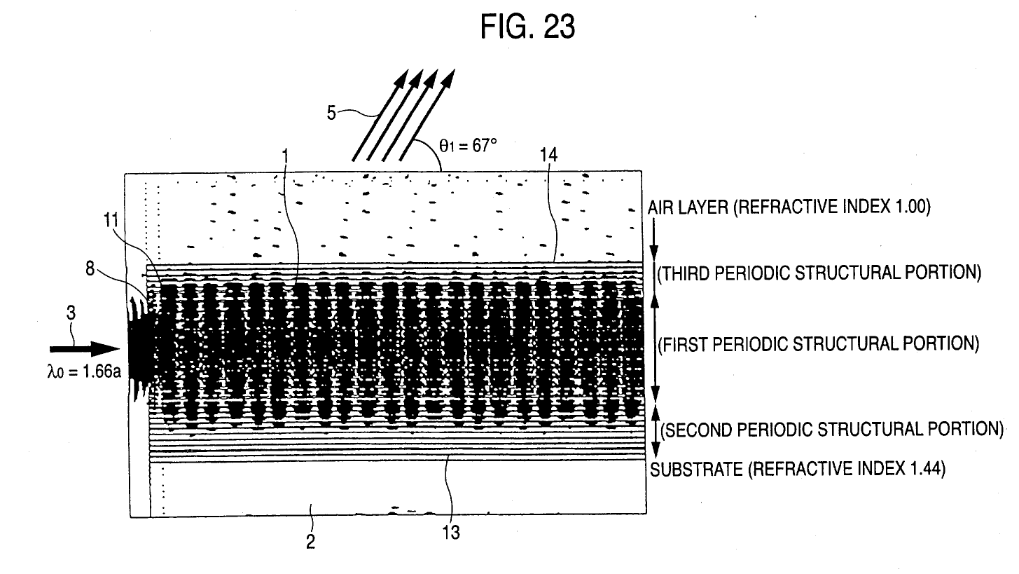

As a result of the simulation, an electric field intensity distribution in the case of λ₀=1.66a is shown in FIG. 23. It is obvious from comparison of FIG. 23 with FIG. 21 that the angle θ₁ of refraction of the refracted light 5 on the air side is unchanged but the intensity of the refracted light 5 is reduced greatly by the third periodic structure 14 provided on the air side.

### Applied Example 1

### Spectroscopic Device

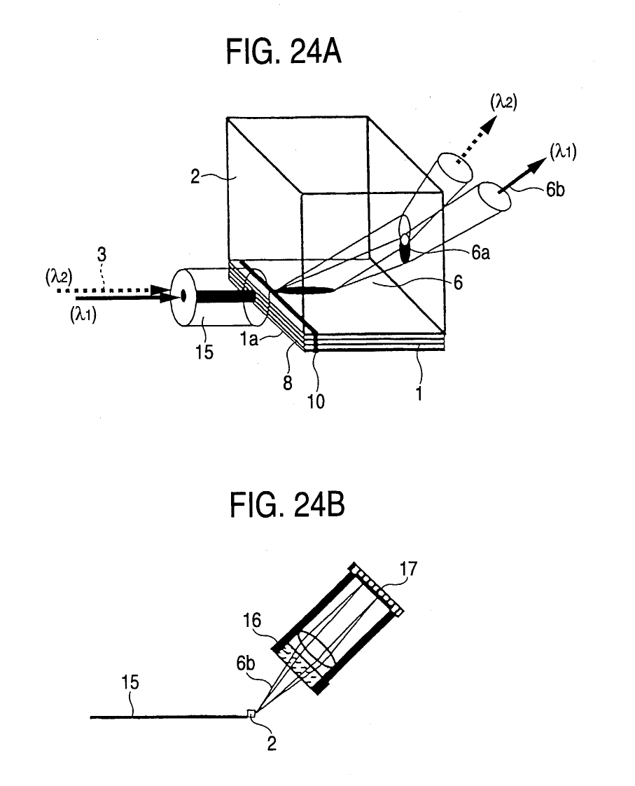

FIG. 24A is a typical view of a main portion of a wavelength monitoring apparatus as an applied example of the invention for individually measuring intensity of each of wavelengths in a wavelength division multiplexed (WDM) signal. FIG. 24B is a typical view of a photo acceptance optical system of the wavelength monitoring apparatus.

A groove 10 is formed near an end surface of the multilayer film 1, so that the outer side of the groove is used as a phase grating portion 8. Input light 3 is incident onto the phase grating portion 8 in the condition that a core of an optical fiber 15 (as a part of light providing means) is made to abut on an end surface of the phase grating portion 8 directly. While the input light 3 is propagated as third band propagated light through the multilayer film 1 by the function of the phase grating portion 8, the propagated light is gradually taken out as refracted light 6 from a surface of the multilayer film 1. FIG. 24A shows the case where refracted light 6 is taken out on the substrate 2 side. If the input light 3 from the optical fiber 15 contains multi-wavelength signals, light rays at respective wavelengths form pencils of refracted light rays different in angle.

Because the refracted light rays 6 are focused on spots different according to the wavelengths by the photo acceptance optical system shown in FIG. 24B, the intensity of each spot can be individually measured by a sensor array 17.

Incidentally, each output portion 6a of the refracted light 6 is remarkably elliptic as shown in FIG. 24A, so that each output light 6b also forms a nearly elliptic Gaussian beam. Therefore, as shown in FIG. 24B, the shape of each output beam 6b is modified by a cylindrical lens 16 so that a focused spot nearer to a circle can be obtained.

### Applied Example 2

### External Resonator of Laser

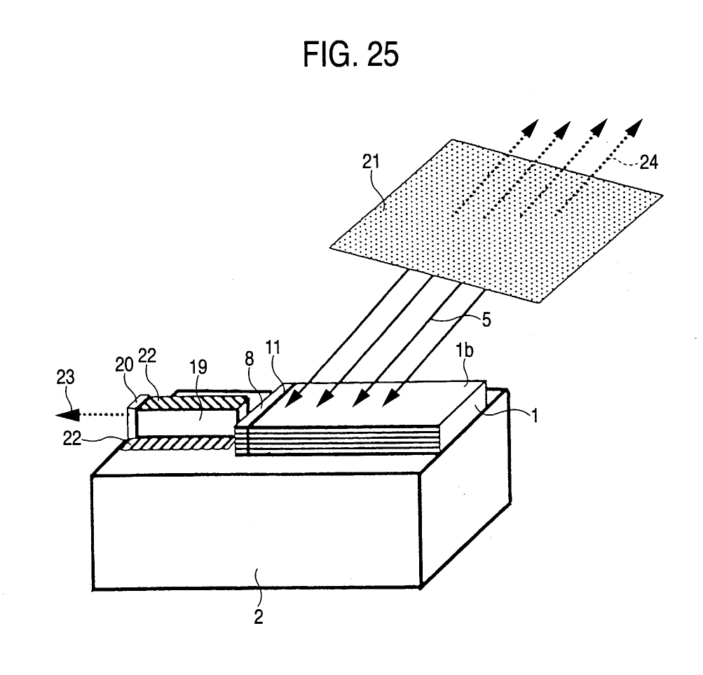

FIG. 25 is a typical view of an external resonator-containing semiconductor laser device as an applied example of the invention.

A waveguide-like active layer 19 as light providing means and a multilayer film 1 are formed on a substrate 2. A reflecting mirror 20 is provided on a single side of the active layer 19. Electrodes 22 are provided on opposite sides of the active layer 19. Laser oscillation is performed. (A power supply portion is not shown in FIG. 25.) Light output from the multilayer film side of the active layer 19 is propagated in the multilayer film 1 through the phase grating 8 and a space 11, so that refracted light 5 is output from a surface 1b of the multilayer film 1. A reflecting mirror 21 is disposed in a space. Only a part of light having a specific wavelength in the light reflected by the reflecting mirror 21 can return into the multilayer film 1. Accordingly, only the light having the wavelength resonates as oscillatory wave. The wavelength of oscillation can be changed by the angle of the mirror 21.

When the reflecting mirror 20 is provided as a partial reflecting mirror, a laser beam 23 can be taken out on a side opposite to the multilayer film side. A variable wavelength laser device can be achieved by this configuration. When the reflecting mirror 21 is provided as a partial reflecting mirror, a laser beam 24 collimated as thick light flux can be taken out to the obliquely upper right. Incidentally, the basic configuration of such an external resonator-containing variable wavelength semiconductor laser (an example using a diffraction grating as a spectroscopic element) has been described in “The Eighth Mirooptics Conference Technical Digest (2001)”, pp.64-67.

As described above, in accordance with the invention, because refracted light from a multilayer structure has good directivity and the direction of the refracted light has large wavelength dependence, a high-resolving-power spectroscopic device or polarized light separating device can be achieved by using both good directivity and large wavelength dependence of the refracted light without increase in size of the device. Because the multilayer structure can be mass-produced relatively inexpensively by use of a known technique, reduction in cost of these optical elements can be attained.

What is claimed is:

1. An optical element using one-dimensional photonic crystal, comprising:
a multilayer structure containing a periodic structure as at least one region, said periodic structure being regarded as one-dimensional photonic crystal having repetition of a predetermined period, said multilayer structure having an end surface substantially perpendicular to layer surfaces of said multilayer structure and used as a light input surface, wherein:
said optical element further comprises a phase modulation unit disposed adjacent or abutting to said light input surface for generating phase-modulated wave having a period the same as the period of said periodic structure in a laminating direction of said multilayer structure; and
at least one of opposite surfaces of said multilayer structure which are substantially parallel to layer surfaces of said multilayer structure is used as a light output surface.

2. An optical element using one-dimensional photonic crystal according to claim 1, wherein said optical element satisfies a condition:
0<ks·λ₀/(2π·ns₂)<1
in which
λ₀ is a wavelength of light in a vacuum when the light is incident onto said optical element,
ks is a magnitude of a wave vector in a coupled photonic band, which is not the lowest, of said photonic crystal in a direction parallel to said layer surfaces in accordance with said wavelength λ₀, and
ns₁ and ns₂ (ns₂≦ns₁) are refractive indices of media, respectively, coming into contact with opposite surfaces of said multilayer structure.

3. An optical element using one-dimensional photonic crystal according to claim 1, wherein said optical element satisfies conditions:
0<ks·λ₀/(2π·ns₁)<1, and
1<ks·λ₀/(2π·ns₂)
in which
λ₀ is a wavelength of light in a vacuum when the light is incident onto said optical element,
ks is a magnitude of a wave vector in a coupled photonic band, which is not the lowest, of said photonic crystal in a direction parallel to said layer surfaces in accordance with said wavelength λ₀, and
ns₁ and ns₂ (ns₂≦ns₁) are refractive indices of media, respectively, coming into contact with opposite surfaces of said multilayer structure.

4. An optical element using one-dimensional photonic crystal according to claim 1, wherein a second periodic structural portion is provided between said periodic structural portion and a medium having a refractive index ns satisfying a condition:
0<ks·λ₀/(2π·ns)<1
in which
λ₀ is a wavelength of light in a vacuum when the light is incident onto said optical element,
ks is a magnitude of a wave vector in a coupled photonic band, which is not the lowest, of said photonic crystal in a direction parallel to said layer surfaces in accordance with said wavelength λ₀, and
ns₁ and ns₂ (ns₂≦ns₁) are refractive indices of media, respectively, coming into contact with opposite surfaces of said multilayer structure.

5. An optical element using one-dimensional photonic crystal according to claim 1, wherein a reflecting layer is provided between said periodic structural portion and a medium having a refractive index ns satisfying a condition:
0<ks·λ₀/(2π·ns)<1
in which
λ₀ is a wavelength of light in a vacuum when the light is incident onto said optical element,
ks is a magnitude of a wave vector in a coupled photonic band, which is not the lowest, of said photonic crystal in a direction parallel to said layer surfaces in accordance with said wavelength λ₀, and
ns₁ and ns₂ (ns₂≦ns₁) are refractive indices of media, respectively, coming into contact with opposite surfaces of said multilayer structure.

6. An optical element using one-dimensional photonic crystal according to claim 5, wherein said reflecting layer is constituted by a periodic structural portion different from said periodic structural portion.

7. An optical element using one-dimensional photonic crystal, comprising:
a multilayer structure containing a periodic structure as at least one region, said periodic structure being regarded as one-dimensional photonic crystal having repetition of a predetermined period, said multilayer structure having a surface substantially parallel to layer surfaces of said multilayer structure and used as a light input surface, wherein:
said optical element further comprises a phase modulation unit disposed adjacent or abutting to said light input surface for generating phase-modulated wave having a period the same as the period of said periodic structure in a laminating direction of said multilayer structure; and
an end surface of said multilayer structure which is substantially perpendicular to layer surfaces of said multilayer structure is used as a light output surface.

8. An optical element using one-dimensional photonic crystal according to claim 7, wherein said optical element satisfies a condition:
0<ks·λ₀/(2π·ns₂)<1
in which
λ₀ is a wavelength of light in a vacuum when the light is incident onto said optical element,
ks is a magnitude of a wave vector in a coupled photonic band, which is not the lowest, of said photonic crystal in a direction parallel to said layer surfaces in accordance with said wavelength λ₀, and
ns₁ and ns₂ (ns₂≦ns₁) are refractive indices of media, respectively, coming into contact with opposite surfaces of said multilayer structure.

9. An optical element using one-dimensional photonic crystal according to claim 7, wherein said optical element satisfies conditions:
0<ks·λ₀/(2π·ns₁)<1, and
1<ks·λ₀/(2π·ns₂)
in which
λ₀ is a wavelength of light in a vacuum when the light is incident onto said optical element,
ks is a magnitude of a wave vector in a coupled photonic band, which is not the lowest, of said photonic crystal in a direction parallel to said layer surfaces in accordance with said wavelength λ₀, and
ns₁ and ns₂ (ns₂≦ns₁) are refractive indices of media, respectively, coming into contact with opposite surfaces of said multilayer structure.

10. An optical element using one-dimensional photonic crystal according to claim 7, wherein a second periodic structural portion is provided between said periodic structural portion and a medium having a refractive index ns satisfying a condition:
0<ks·λ₀/(2π·ns)<1
in which
λ₀ is a wavelength of light in a vacuum when the light is incident onto said optical element,
ks is a magnitude of a wave vector in a coupled photonic band, which is not the lowest, of said photonic crystal in a direction parallel to said layer surfaces in accordance with said wavelength λ₀, and
ns₁ and ns₂ (ns₂≦ns₁) are refractive indices of media, respectively, coming into contact with opposite surfaces of said multilayer structure.

11. An optical element using one-dimensional photonic crystal according to claim 7, wherein a second periodic structural portion is provided between said periodic structural portion and a medium having a refractive index ns satisfying a condition:
0<ks·λ₀/(2π·ns)<1
in which
λ₀ is a wavelength of light in a vacuum when the light is incident onto said optical element,
ks is a magnitude of a wave vector in a coupled photonic band, which is not the lowest, of said photonic crystal in a direction parallel to said layer surfaces in accordance with said wavelength λ₀, and
ns₁ and ns₂ (ns₂≦ns₁) are refractive indices of media, respectively, coming into contact with opposite surfaces of said multilayer structure.

12. An optical element using one-dimensional photonic crystal according to claim 11, wherein said reflecting layer is constituted by a periodic structural portion different from said periodic structural portion.

13. An optical device comprising:
an optical element constituted by a multilayer structure defined in claim 1;
an input unit for inputting light flux at mixed wavelengths into an end surface of the periodic structural portion of said multilayer structure; and
a detecting unit for detecting light rays output at different angles according to wavelengths from a light output surface of said multilayer structure.

14. An optical device comprising:
an optical element constituted by a multilayer structure defined in claim 7;
an input unit for inputting light flux at mixed wavelengths into an end surface of the periodic structural portion of said multilayer structure; and
a detecting unit for detecting light rays output at different angles according to wavelengths from a light output surface of said multilayer structure.

15. An optical device comprising:
an optical element constituted by a multilayer structure defined in claim 1;
a semiconductor laser optically coupled to said optical element; and
a reflecting mirror for reflecting light output from said optical element to return the light to said optical element.

16. An optical device comprising:
an optical element constituted by a multilayer structure defined in claim 7;
a semiconductor laser optically coupled to said optical element; and
a reflecting mirror for reflecting light output from said optical element to return the light to said optical element.

17. An optical device comprising:
a multilayer structure containing a periodic structure having repetition of a predetermined period in a laminating direction thereof, said multilayer structure having a first end surface substantially perpendicular or parallel to layer surfaces of said multilayer structure and a second end surface substantially perpendicular to said first end surface of said multilayer structure;
a light providing means for providing light to said multilayer structure;
a phase modulation unit for generating phase-modulated wave having a period the same as the period of said periodic structure; and
wherein the phase modulation unit is disposed between said multilayer structure and said light providing unit and
the light provided by said light providing means is output from the second end surface of the multilayer structure.

18. An optical device according to claim 17, wherein said phase modulation unit disposed adjacent or abutting to said first end surface of said multilayer structure.

19. An optical device according to claim 17, wherein said light providing means includes an optical fiber.

20. An optical device according to claim 19, said optical fiber is made to abut on an end surface of said phase modulation unit directly.

21. An optical device according to claim 17, wherein said light providing means provides the light containing multi-wavelength signals.

22. An optical device according to claim 17, wherein the light output from the second end surface of the multilayer structure contains a plurality of light rays at different wavelength, and the light rays are refracted differently in angle.

23. An optical device according to claim 22, the optical device further comprises a sensor array which receives the light output from the second end surface of said multilayer structure so that intensity of each of wavelengths are individually measured.

24. An optical device according to claim 17, wherein said light providing means includes an active layer, and
the light output from the second end surface of said multilayer structure is reflected by a mirror so as to return into said multilayer structure,
whereby the light having a predetermined wavelength resonates as oscillatory wave.
